(19) United States
(12) Patent Application Publication
(10) Pub. No.: US 2009/0122279 A1
(43) Pub. Date: May 14, 2009

(54) PROJECTOR

(75) Inventor: Nobutaka MINEFUJI, Azumino-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/264,650

(22) Filed: Nov. 4, 2008

(30) Foreign Application Priority Data
Nov. 8, 2007 (JP) 2007-290462

(51) Int. Cl. G03B 21/28

(52) U.S. Cl. 353/99

(57) ABSTRACT

A projector includes a screen; a reflection unit having at least one curved surface mirror disposed on the projection side of the screen; a bending mirror disposed before the reflection unit on the optical path and disposed on either the non-projection side of the screen or on an extension plane of the screen; a refraction unit disposed before the reflection unit on the optical path and having at least a part disposed on either the non-projection side of the screen or on the extension plane of the screen; and an image forming unit disposed before the refraction unit on the optical path and disposed on the non-projection side of the screen.

### BACKGROUND

1. Technical Field

The present invention relates to a projector for projecting an image formed by a liquid crystal panel or the like on a screen.

2. Related Art

As a technology for projecting an image on a screen by using a projector disposed in the vicinity of the screen, a method which locates a projector below the screen and reflects an image by an upper mirror to project the image on the screen (for example, see JP-A-2-196230), a method which locates a projector behind the screen and repeats projection by using two flat plates (for example, see JP-A-10-206969), and other methods have been proposed. Also, there are other method which directly attaches the projector on an arm extending from the screen (for example, see JP-T-2002-538508), and method which provides enlarged close projection on the screen by using a projection system which includes refraction system containing plural lenses and a reflection mirror (for example, see JP-A-2004-258620 and JP-A-2006-235516).

According to the projection system using the refractive lens system as disclosed in JP-A-2-196230 and JP-A-10-206969, however, a wide angle lens included in this system has a half angle of view of only about 45°, and thus the projection size becomes small. In this case, sufficient distance between the lens and the mirror is needed for obtaining large projection size. Thus, the size of the mirror increases accordingly.

According to the projection method disclosed in JP-T-2002-538508, a large-sized aspherical lens is employed. In this case, the projection system has an ultra-wide angle lens having a half angle of view of almost 60° attached to the arm for close projection. In the projection system using this ultra-wide lens, however, the projection distance of about 1 m is necessary to project an image on an about 80-inch screen. In this case, increase in the arm strength and the screen frame strength for supporting the whole system is required. Thus, the entire size and cost of the system increase.

According to the projection methods disclosed in JP-A-2004-258620 and JP-A-2006-235516, the refraction system of the projection optical system extends perpendicular to the screen. Thus, size reduction of the entire device is limited.

### SUMMARY

It is an advantage of some aspects of the invention to provide a projector capable of easily achieving size and cost reduction and meeting the demand for wider lens.

A projector according to an aspect of the invention includes a screen, a reflection unit having at least one curved surface mirror disposed on the projection side of the screen; a bending mirror disposed before the reflection unit on the optical path and disposed on either the non-projection side of the screen or on an extension plane of the screen; a refraction unit disposed before the reflection unit on the optical path and having at least a part disposed on either the non-projection side of the screen or on the extension plane of the screen; and an image forming unit disposed before the refraction unit on the optical path and disposed on the non-projection side of the screen.

According to this projector, the entire or partial area of the refraction unit and the image forming unit are disposed on the non-projection side of the screen or on the extension plane of the screen. In this case, the projection light released from the image forming unit is bended by the bending mirror in the vicinity of the screen and guided toward the area before the screen. The bended projection light reaches the reflection unit on the projection side of the screen to provide close projection on the screen. When the refraction unit and the reflection unit are disposed with the screen interposed therebetween, for example, the positioning of the reflection unit, the refraction unit and the image forming unit can be balanced by disposed on the non-projection side and the projection side of the screen and contribute to space-saving. Thus, the entire thickness of the projector can be reduced. Moreover, the reflection unit is a curved surface mirror. In this case, the size of the curved surface mirror can be reduced, and extrusion of the projector toward the projection side of the screen can be decreased. Accordingly, the projection size of the projector on the screen can be increased with reduced size and cost of the projector.

It is preferable that the curved surface mirror has either a concave surface or a convex surface as a curved reflection surface. When the curved surface mirror has a concave surface, extrusion of the curved surface mirror to below is smaller than that of the curved surface mirror as the convex surface. In this case, the projection image can be enlarged with reduced projection space before the screen. When the curved surface mirror is a convex surface, the projection size is larger than that of the concave surface. Moreover, the radius of curvature of the convex surface mirror can be made smaller than that of the concave surface mirror. Thus, manufacture of the convex surface mirror is easier. The curved reflection surface herein refers to a reflection optical surface which reflects real projection light by a curved surface mirror.

It is preferable that a projection distance from the reflection curved surface of the curved surface mirror to the screen is shorter than a distance from the reflection curved surface of the curved surface mirror to the bending mirror. According to this structure, the curved surface mirror is disposed on the screen projection side, and the image forming unit is disposed on the screen non-projection side. Thus, the weight balance becomes preferable, and the necessity for increasing strengths of the frame and leg of the screen and the size of the screen is eliminated. The reflection curved surface herein refers to a virtual surface which contains a non-real curved surface of the curved surface mirror and having a surface top passing the optical axis as a reference.

It is preferable that the refraction unit has a plurality of lenses. According to this structure, the angle of view can be increased with high accuracy, and the variable power function can be added.

It is preferable that the bending mirror is disposed between the plural lenses. According to this structure, the distance between the curved surface mirror and the exit side end of the refraction unit can be shortened, and thus the curved surface mirror can be made relatively compact.

It is preferable that the all or partial optical axis of the plural lenses is disposed parallel with the extension plane of the screen on either the non-projection side of the screen or the extension plane of the screen. According to this structure, the plural lenses are disposed in parallel on either the non-projection side or the extension plane of the screen, and thus the space for disposing the refraction unit can be reduced.

It is preferable that the bending mirror is disposed on the exit side of the refraction unit. This structure is simple which includes the refraction unit and the image forming unit on the non-projection side or extension plane of the screen. According to this structure, the projection light from the refraction unit is bended by the bending mirror in the vicinity of the screen toward the area before the screen. The bended projection light is reflected by the curved surface mirror disposed closer to the screen. Thus, the projection image can be enlarged with reduction of the projection space on the front side of the screen.

It is preferable that the image forming unit has an image forming element. In this structure, various images formed by the image forming element can be projected on the screen. The image forming element is formed by a liquid crystal light valve, for example.

### BRIEF DESCRIPTION OF THE DRAWINGS

The invention will be described with reference to the accompanying drawings, wherein like numbers reference like elements.

FIG. 1 illustrates a concept of a main part structure of a projector according to a first embodiment.

FIG. 2 illustrates light condition within the projector shown in FIG. 1.

FIG. 3 is an enlarged view showing the light condition shown in FIG. 2.

FIG. 4 illustrates a concept of an image forming unit.

FIG. 5 illustrates an installation example of the projector according to the first embodiment.

FIG. 6 illustrates a concept of a main part structure of a projector according to a second embodiment.

FIG. 7 illustrates light condition within the projector shown in FIG. 6.

FIG. 8 is an enlarged view showing the light condition shown in FIG. 7.

FIG. 9 illustrates a concept of a main part structure of a projector according to a third embodiment.

FIG. 10 illustrates light condition within the projector shown in FIG. 9.

FIG. 11 is an enlarged view showing the light condition shown in FIG. 10.

FIGS. 12A through 12C are side view, plan view, and front view illustrating a main part structure of a projector according to a fourth embodiment.

FIGS. 13A and 13B illustrate a modified installation example of FIG. 5.

### DESCRIPTION OF EXEMPLARY EMBODIMENTS

### First Embodiment

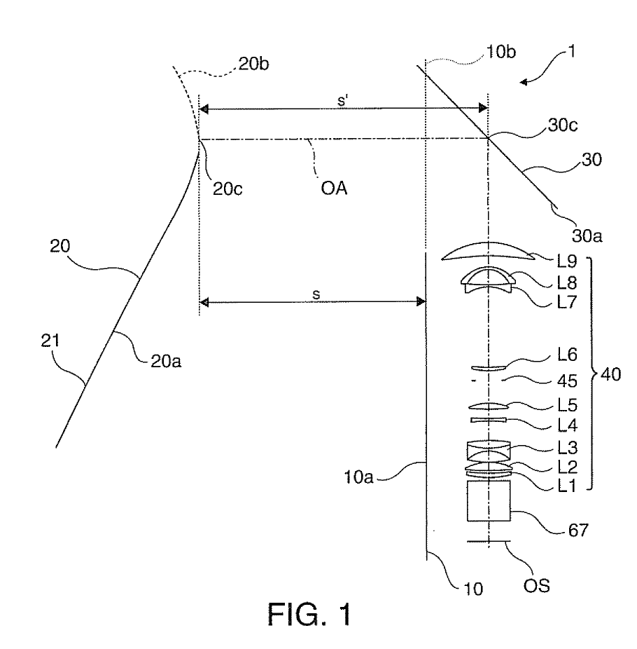

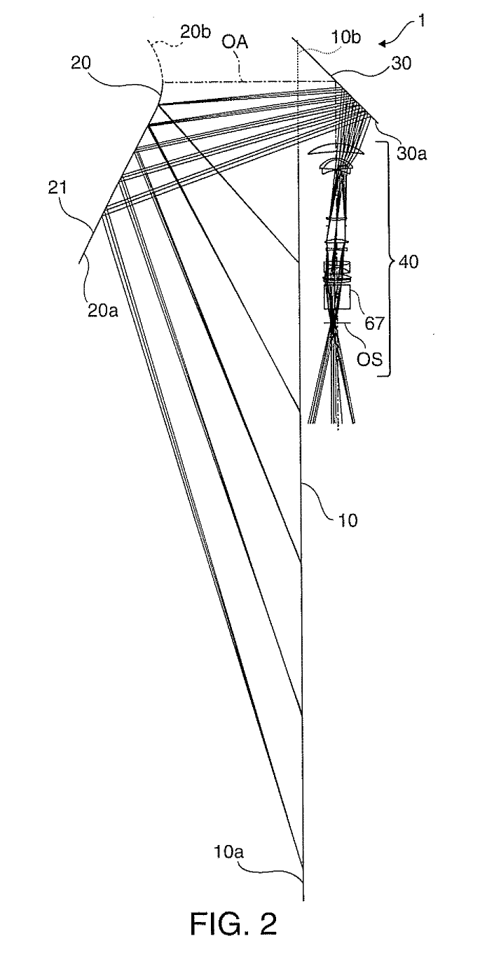

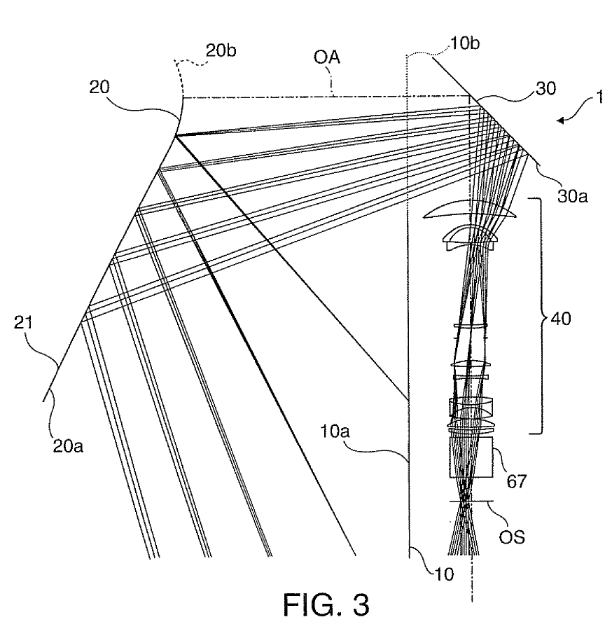

FIGS. 1 through 3 are side views illustrating a main part of a projector according to a first embodiment of the invention. FIG. 1 illustrates a concept of the main part structure of the projector. FIG. 2 illustrates light condition within the projector. FIG. 3 is an enlarged view of FIG. 2.

A projector 100 in this embodiment includes a screen 10, a reflection unit 20, a bending mirror 30, a refraction unit 40, and an image forming unit 60. In this structure, the reflection unit 20 and the refraction unit 40 constitutes a projection system 1. In FIGS. 1 through 3, only a cross dichroic prism 67 is shown in the image forming unit 60 as a part thereof, and other parts of the image forming unit 60 are not shown.

The screen 10 is a reflection type projection plate, and displays an image by diffuse reflect of projection light via a screen projection surface 10a. The screen 10 is made of white plastic plate, for example. The screen 10 may be manufactured by applying coating containing beads or pearls to the substrate surface, or by embedding a micro-lens or micro-mirror into the substrate surface.

The reflection unit 20 has one curved surface mirror 21. The curved surface mirror 21 is a convexed surface reflection mirror constituted by rotation-symmetric surface around an optical axis OA. The curved surface mirror 21 has a reflection surface 20a (indicated by a solid line in FIG. 1 or other figures) below the optical axis OA which reflects the projection light emitted toward the front from the non-projection side of the screen 10, that is, the back side of the screen 10 toward the screen projection surface 10a. A part indicated by a broken line in FIG. 1 or other figures, that is, the part above the optical axis OA indicates a non-real curved surface 20b as a virtual extension surface of the curved surface mirror 21. The curved surface mirror 21 is positioned in a space above the projection side of the screen 10.

The bending mirror 30 is a flat reflection plate which bends the projection light emitted to above from the refraction unit 40 toward the front of the screen 10 by a reflection surface 30a, and guides the projection light to the projection side of the screen, that is, the surface side of the screen 10. The bending mirror 30 is disposed above the non-projection side of the screen 10 and the exit side of the refraction unit 40. More specifically, a distance s′ between a cross point 30c of the bending mirror 30 and the optical axis OA and a surface top 20c of the curved surface mirror 21 is longer than a distance s between the surface top 20c of the curved surface mirror 21 and the screen projection surface 10a. The bending mirror 30 has an inclination of 45° to the optical axis of the curved surface mirror 21 and the optical axis OA of the refraction unit 40.

The refraction unit 40 is disposed on the non-projection side of the screen 10 and on the exit side of the image forming unit 60. The refraction unit 40 is constituted by a plurality of refractive lenses.

A specific lens structure of the retraction unit 40 is now discussed.

The refraction unit 40 shown in FIG. 1 or other figures has function of enlarging an image on an object surface OS and projecting the enlarged image on the screen 10. The refraction unit 40 has a first lens L1, a second lens L2, a third lens L3, a fourth lens L4, a fifth lens L5, a sixth lens L6, a seventh lens L7, an eighth lens L8, a ninth lens L9, and a stop 45.

The lenses L1 through L9 are disposed in this order from the object surface OS as a contraction side (lower side in FIG. 1) toward the side above the screen 10 as an expansion side (upper side in FIG. 1). The optical axis of the respective lenses L1 through L9, that is, the optical axis OA of the refraction unit 40 is disposed in parallel with an extension plane 10b of the screen 10. In this case, the stop 45 is disposed between the fifth lens L5 and the sixth lens L6.

The first lens L1 and the eighth lens L8 are aspheical lenses. The second lens L2 is a both-convex lens, and the third lens L3 is a junction lens having both-convex three lenses. The fourth lens L4, the fifth lens L5, and the seventh lens L7 are both-concave lenses. The sixth lens L6 and the ninth lens L9 are meniscus lenses. The positions of the respective lenses L1 through L9 are controlled such that the optimum projection can be provided on the screen 10 by the control of the relation with the reflection unit 20 in shape and position.

The refraction unit 40 is constructed such that the object surface OS side becomes substantially telecentric. The cross dichroic prism 67 for combining images in three colors is disposed between the first lens L1 at the front end of the refraction unit 40 and the object surface OS on which the liquid crystal panel is disposed. The object surfaces on which the liquid crystal panels for the other two colors are disposed are not shown in the figure, but are located at equivalent positions, that is, conjugate positions of the object surface OS shown in the figure. As illustrated in FIG. 1 or other figures, lights providing constant spread and having a chief ray vertical to the object surface OS and parallel to the optical axis OA are emitted from the respective object points on the object surface OS. The emitted lights travel to above, and pass the refraction unit 40. Then, the lights are reflected by the reflection unit 20 and the like and projected on the screen projection surface 10a.

Table 1 shows lens data of the refraction unit 40.

TABLE 1
Lens Data

| face No. | R | D | Nd | Nv |
|---|---|---|---|---|
| 0 | infinite | 22.50 | | |
| 1 | infinite | 38.00 | 1.51680 | 64.2 prism |
| 2 | infinite | 3.00 | | |
| 3 aspheric | 300.000 | 4.50 | 1.52473 | 56.7 |
| 4 aspheric | −200.000 | 2.00 | | |
| 5 | 212.269 | 8.00 | 1.58913 | 61.3 |
| 6 | −50.587 | 010 | | |
| 7 | 109.704 | 10.50 | 1.49700 | 81.6 |
| 8 | −31.149 | 2.50 | 1.80518 | 25.5 |
| 9 | 77.554 | 7.50 | 1.48749 | 70.4 |
| 10 | −121.247 | 1.51 | | |
| 11 | infinite | 16.77 | | |
| 12 | −124.247 | 2.00 | 1.69895 | 30.1 |
| 13 | 183.928 | 10.14 | | |
| 14 | 551.842 | 4.50 | 1.84666 | 23.8 |
| 15 | −58.941 | 21.48 | | |
| stop | infinite | 9.53 | | |
| 17 | 118.349 | 3.00 | 1.84666 | 23.8 |
| 18 | 193.631 | 77.04 | | |
| 19 | −39.998 | 2.00 | 1.84666 | 23.8 |
| 20 | −216.629 | 15.07 | | |
| 21 aspheric | −16.108 | 3.50 | 1.52473 | 56.7 |
| 22 aspheric | −19.866 | 0.00 | | |
| 23 | infinite | 9.44 | | |
| 24 | −205.607 | 12.50 | 1.69680 | 55.5 |
| 25 | −74.503 | 100.00 | | |
| 26 | infinite | 0.00 | reflection | flat surface |
| | | | surface | mirror |
| 27 | infinite | −280.00 | | |
| 28 aspheric | −63.261 | 0.00 | reflection | curved surface |
| | | | surface | mirror |
| 29 | infinite | 0.00 | | |
| 30 | infinite | 220.00 | | |
| screen | infinite | 0.00 | | |

Aspherical Surface Coefficient

| face No. | K | A04 | A06 | A08 | A10 | A12 |
|---|---|---|---|---|---|---|
| 3 | 0.0000E+00 | 4.1772E−06 | 6.3960E−09 | 0.0000E+00 | 0.0000E+00 | 0.0000E+00 |
| 4 | 0.0000E+00 | 4.2093E−06 | 5.3389E−09 | 1.3885E−12 | 0.0000E+00 | 0.0000E+00 |
| 21 | −2.0647E+00 | −4.9272E−06 | −3.2124E−09 | 2.6878E−11 | 0.0000E+00 | 0.0000E+00 |
| 22 | −1.3492E+00 | 1.6609E−05 | −2.6133E−08 | 9.3100E−12 | 0.0000E+00 | 0.0000E+00 |
| 28 | −3.8298E+00 | 4.6586E−09 | −5.9724E−14 | 4.3236E−19 | −1.3096E−24 | 0.0000E+00 |

In the upper columns in table 1, the “face No.” refers to the number given to each of the lens face in the order from the object surface OS. The “r” refers to a radius of curvature, and “D” refers to a lens thickness from the next face or an air space. Also, the “Nd” refers to refractive index on a d line of a lens material, and “Nv” refers to an Abbe number on the d line of the lens material.

According to this embodiment, the lenses L1 through L9 are basically constituted by spherical surfaces. However, the entrance and exit surfaces of the first lens L1 (Nos. 3 and 4 faces in Table 1) and the entrance and exit surfaces of the eighth lens L8 (Nos. 21 and 22 faces in Table 1) are aspherical surfaces. Also, the reflection surface of the curved surface mirror 21 (No. 28 face in Table 1) is an aspherical surface. The third lens L3 is constituted by a junction lens having three lenses. A displacement amount x of these aspherical shapes from the surface top in the optical axis direction is expressed by the following equation, wherein c: inverse number of paraxial radius of curvature; h: height from optical axis; k: cone coefficient; and A04 through A12: high-degree aspherical surface coefficients.

$$x = \frac{c \cdot {h}^{2}}{1 + \sqrt{1 - ( 1 + k ) \cdot {c}^{2} \cdot {h}^{2}}} + A 04 \cdot {h}^{4} + A 06 \cdot {h}^{6} + A 08 \cdot {h}^{8} + A 10 \cdot {h}^{10} + A 12 \cdot {h}^{12} \qquad Equation 1$$

In this embodiment, the values of the respective coefficients “k” and “A04” through “A12” in the above aspherical surface equation are shown in the lower columns in Table 1.

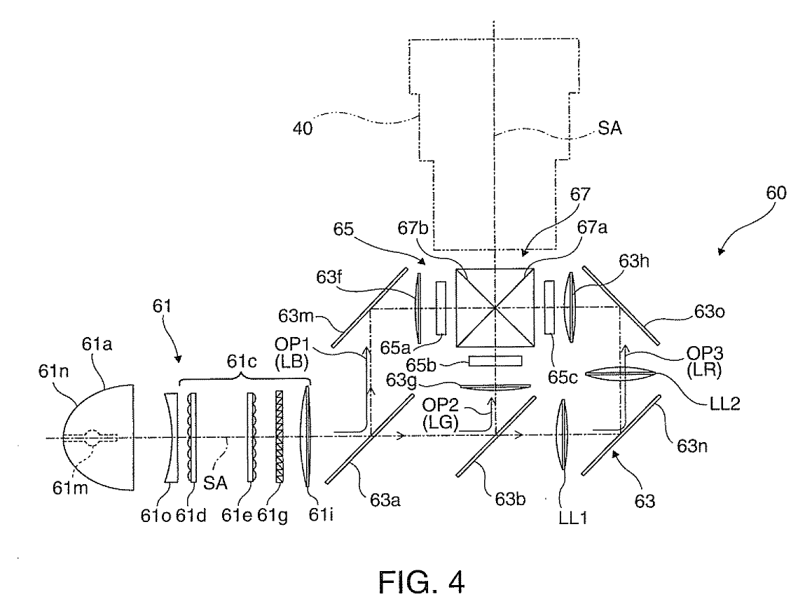

FIG. 4 illustrates a concept of the image forming unit 60. The image forming unit 60 includes a light source device 61 which emits equalized source light along a system optical axis SA, a separation illumination system 63 which separates the illumination light emitted from the light source device 61 into lights in three colors of red, green and blue, a light modulation unit 65 which receives the illumination lights in respective colors released from the separation illumination system 63, and the cross dichroic prism 67 which combines the modulated lights in respective colors having passed through the light modulation unit 65. The image forming unit 60 is disposed on the non-projection side, that is, the back surface side of the screen 10 shown in FIG. 1. The image light released from the cross dichroic prism 67 is projected on the refraction unit 40.

The light source device 61 has a light source unit 61a for emitting source light, and an equalizing system 61c for converting the source light emitted from the light source unit 61a into-uniform illumination light having a predetermined polarization direction. The light source unit 61a has a light source lamp 61m and a reflector 61n. The equalizing system 61c has a first lens array 61d for dividing the source light into partial lights, a second lens array 61e for controlling the spread of the partial lights after division, a polarization light converting device 61g for equalizing the polarization direction of the respective partial lights, and a superimposing lens 61i for supplying the respective partial lights to a target illumination area such that the partial lights are superimposed thereon.

The separation illumination system 63 has first and second dichroic mirrors 63a and 63b, and optical path bending mirrors 63m, 63n, and 63o. The separation illumination system 63 divides the system optical axis SA into three optical paths OP1 through OP3 to separate the illumination light into three lights of blue light LB, green light LG, and red light LR. Relay lenses LL1 and LL2 transmit the image formed immediately before the first relay lens LL1 on the entrance side to a field lens 63h on the exit side substantially with no change to prevent decrease in the light utilization efficiency caused by diffusion of light or for other reasons.

The light modulation unit 65 has three liquid crystal light valves 65a, 65b, and 65c, and the three illumination lights LB, LG, and LR enter the corresponding light valves 65a, 65b and 65c. The light modulation unit 65 modulates the intensities of the respective color lights LB, LG and LR having entered the liquid crystal light valves 65a, 65b and 65c via field lenses 63f, 63g and 63h for each pixel according to driving signals. Each of the liquid crystal light valves 65a, 65b and 65c is constituted by an image forming element having a liquid crystal panel sandwiched between a pair of polarization plates. Each of the liquid crystal panels forming the liquid crystal light valves 65a, 65b and 65c corresponds to the object surface OS shown in FIG. 1 or other figures.

The cross dichroic prism 67 has dichroic films 67a and 67b crossing each other, and releases image light formed by combining modulation lights from the liquid crystal light valves 65a, 65b and 65c. The image light combined by the cross dichroic prism 67 is projected on the not-shown screen 10 as a color image at an appropriate expansion rate by the refraction unit 40 as a projection lens.

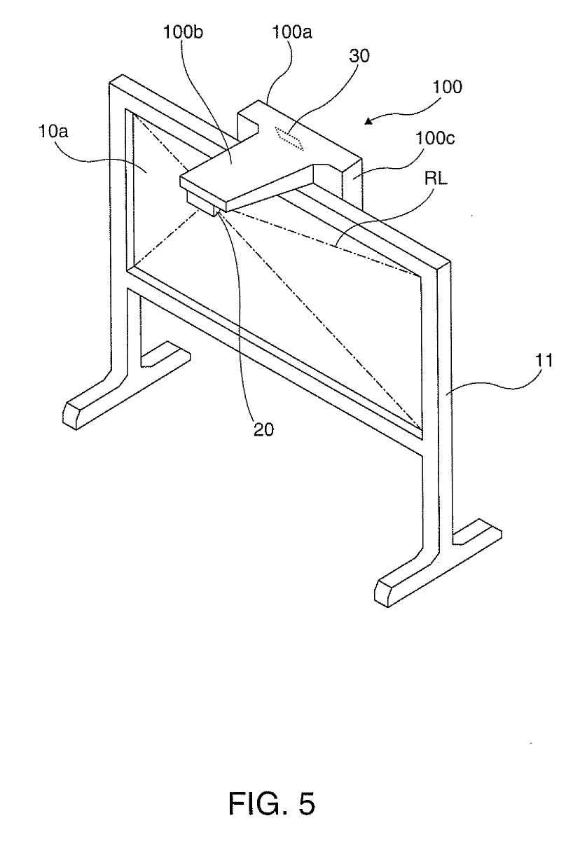

Installation example of the projector 100 is now described with reference to FIG. 5.

As illustrated in FIG. 5, the optical systems of the projector 100 are accommodated in a case 100a, and fixed on a support member 11 of the screen 10. The case 100a has a projection unit 100b on the projection side of the screen 10, and a main body unit 100c on the non-projection side of the screen 10. The projection unit 100b accommodates the reflection unit 20 which slightly projects from the end of the projection unit 100b. The main body unit 100c accommodates the bending mirror 30, the refraction unit 40, and the image forming unit 60, though a part of these components are not shown in the figure. According to the projector 100, the projection unit 100b and the maim body unit 100c are disposed before and behind the screen 10, respectively, such that the weight of the projector 100 in the front-rear direction can be balanced. Since the case 100a is positioned at the center in the left-right direction of the screen projection surface 10a, the case 100a is also balanced in the left-right direction. When compared with a method which installs a projector main body via an arm, the necessity for strengthening the frame and leg of the screen and increasing the size of the screen can be reduced.

The projection light RL released from the image forming unit 60 is supplied to the refraction unit 10 to be enlarged, and then bended toward the projection side of the screen 10 by the bending mirror 30. The bended projection light RL is reflected by the curved surface mirror 21 of the reflection unit 20, and projected on the screen projection surface 10a with relatively small distortion.

According to the projector 100 described above, the projection light bended by the bending mirror 30 around a position above the non-projection side of the screen 10 can be projected on the screen projection surface 10a by close projection using the reflection unit 20 disposed on the projection side of the screen 10. Moreover, the screen 10 is interposed between the reflection unit 20 and the components of the refraction unit 40 and the image forming unit 60. Thus, the reflection unit 20, the refraction unit 40, and the image forming unit 60 can be disposed on the non-projection side and the projection side of the screen 10 with preferable balance, and the entire thickness of the projector 100 can be reduced. Also, the optical axis of the refraction unit 40 is disposed parallel with the extension plane 10b of the screen 10. Thus, the space for disposing the refraction unit 40 can be reduced. Furthermore, the structure of the reflection unit 20 as the curved surface mirror 21 can reduce the size of the curved surface mirror 21 and other parts, which decreases protrusion of the projector 100 toward the projection side of the screen 10. Accordingly, the projector 100 can achieve projection with a large angle of view on the screen 10 while reducing the size and cost of the projector 100.

### Second Embodiment

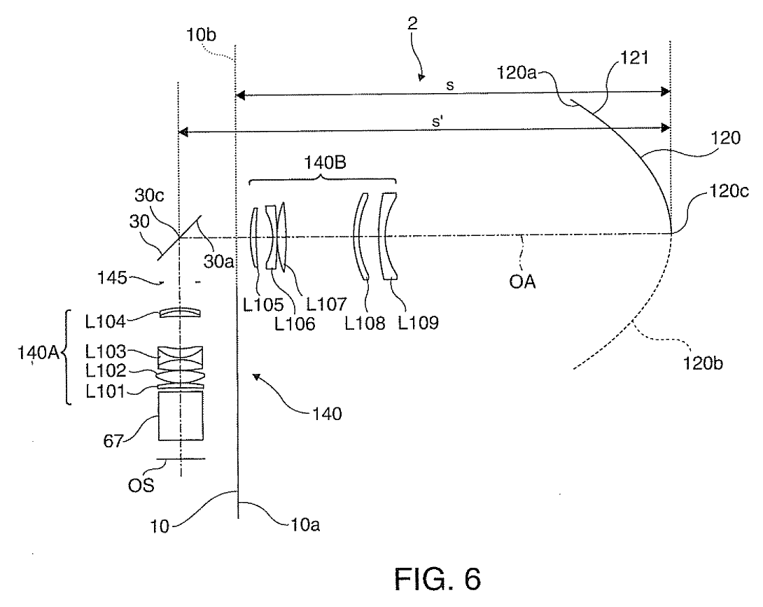

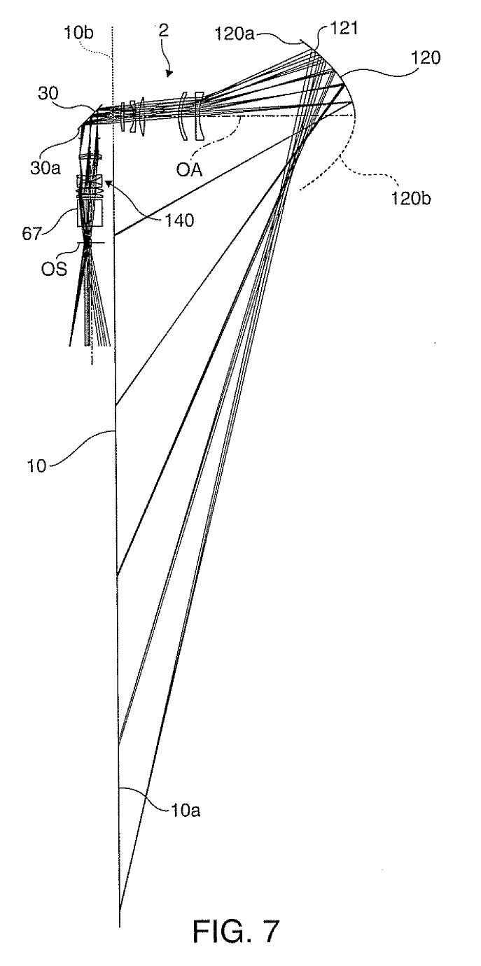

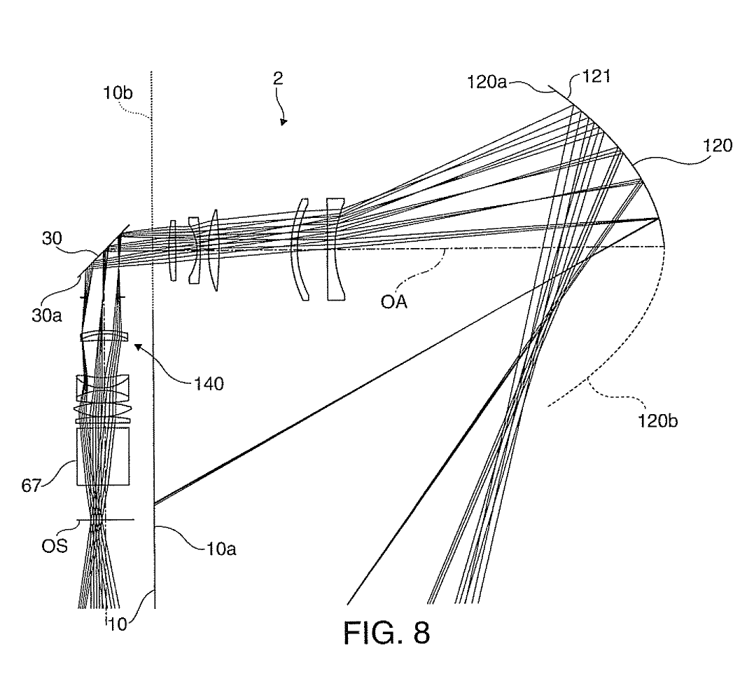

FIGS. 6 through 8 are side views illustrating a main part of a projector according to a second embodiment of the invention. FIG. 6 illustrates a concept of the main part structure of the projector. FIG. 7 illustrates light condition within the projector. FIG. 8 is an enlarged view of FIG. 7. A projector 200 in this embodiment is a modification of the projector 100 in the first embodiment shown in FIG. 1 or other figures, and parts included in the projector 200 similar to those in the projector 100 in the first embodiment are not specifically explained.

The projector 200 in this embodiment includes the screen 10, a reflection unit 120, the bending mirror 30, a refraction unit 140, and the image forming unit 60. In this structure, the reflection unit 120 and the refraction unit 140 constitute a projection system 2. In FIGS. 6 through 8, only the cross dichroic prism 67 as a part of the image forming unit 60 is shown, but other parts are not shown.

The reflection unit 120 has a one curved surface mirror 121. The curved surface mirror 121 is a concaved surface reflection mirror constituted by rotation-symmetric surface around the optical axis OA. The curved surface mirror 121 has a reflection surface 120a (indicated by a solid line in FIG. 6 or other figures) below the optical axis OA which reflects the projection light emitted from the non-projection side of the screen 10 toward the screen projection surface 10a. A part indicated by a broken line in FIG. 6 or other figures, that is, the part above the optical axis OA indicates a non-real curved surface 120b of the curved surface mirror 121. The curved surface mirror 121 is positioned above the projection side of the screen 10.

The bending mirror 30 is a flat reflection plate which bends the projection light by the reflection surface 30a toward the area before the screen 10, and guides the projection light to the projection side of the screen 10. The bending mirror 30 is disposed above the non-projection side of the screen 10 and between the plural lenses of the refraction unit 140 to be described later. More specifically, the distance s′ between the cross point 30c of the bending mirror 30 and the optical axis OA and a surface top 120c of the curved surface mirror 121 is longer than the distance s between the surface top 120c of the curved surface mirror 121 and the screen projection surface 10a. The bending mirror 30 has an inclination of 45° to the optical axis of the curved surface mirror 121 and the optical axis OA of the refraction unit 140.

The refraction unit 140 is disposed on the exit side of the image forming unit 60. The refraction unit 140 is constituted by a plurality of refractive lenses to enlarge the image on the object surface OS and projects the enlarged image on the screen 10.

The refraction unit 140 includes a lens front group 140A, a lens rear group 1408, and a stop 145. The lens front group 140A has a first lens L101, a second lens L102, a third lens L103, and a fourth lens L104. The lens rear group 140B has a fifth lens L105, a sixth lens L106, a seventh lens L107, an eighth lens L108, and a ninth lens L109. The lens front group 140A is disposed on the non-projection side of the screen 10, and the lens rear group 140B is on the projection side of the screen 10. The third lens L103 is constituted by a junction lens having three lenses. The stop 145 is disposed between the lens front group 140A and the lens rear group 140B. The positions of the respective lenses L101 through L109 are controlled such that the optimum projection can be provided on the screen 10 by the control of the relation with the reflection unit 120 in shape and position.

According to this embodiment, the projection light released from the image forming unit 60 passes through the lens front group 140A of the refraction unit 140 and the stop 145, and travels toward the lens rear group 140B after bended by the reflection surface 30a of the bending mirror 30. The projection light released from the refraction unit 140 is reflected by the reflection surface 120a of the curved surface mirror 121, and projected on the screen projection surface 10a.

Accordingly, the projector 200 can achieve projection with a large angle of view on the screen 10 while reducing the size and cost of the projector 200 similarly to the projector 100.

Moreover, the curved surface mirror 121 is a concave surface. Thus, protrusion toward the area below the curved surface mirror 121 is smaller than that of the convex surface. Accordingly, the size of the projection image can be enlarged while reducing the projection space before the screen 10.

Furthermore, the bending mirror 30 is disposed between the plural lenses of the refraction unit 140. Thus, the distance between the curved surface mirror 121 and the exit side end of the refraction unit 140 is shortened. Accordingly, the size of the curved surface mirror 121 can be reduced.

### Third Embodiment

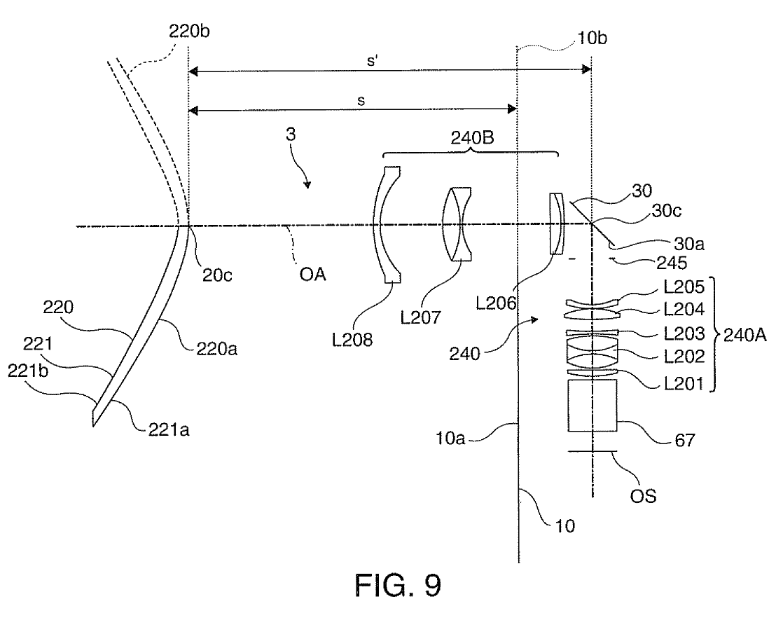

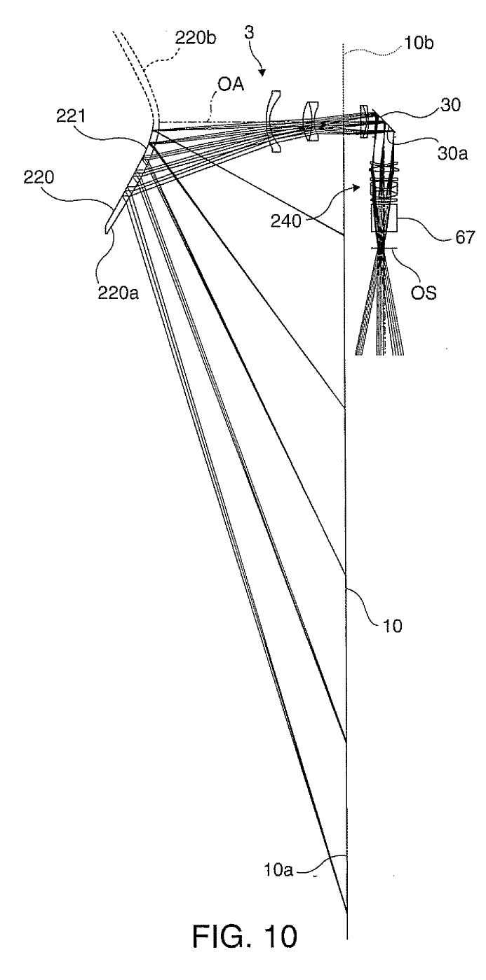

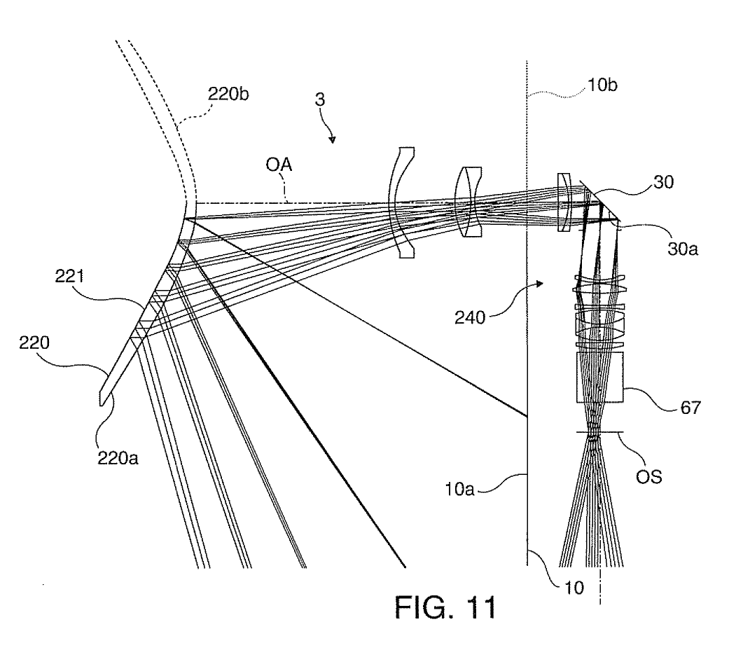

FIGS. 9 through 11 are side views illustrating a main part of a projector according to a third embodiment of the invention. FIG. 9 shows a concept of the main part structure of the projector. FIG. 10 illustrates light condition within the projector. FIG. 11 is an enlarged view of FIG. 10. A projector 300 in this embodiment is a modification of the projectores 100 and 200 according to the first and second embodiment shown in FIGS. 1 and 6, and other figures, and parts included in the projector 300 similar to those in the projectores 100 and 200 in the first and second embodiments are not specifically explained.

The projector 300 in this embodiment includes the screen 10, a reflection unit 220, the bending mirror 30, a refraction unit 240, and the image forming unit 60. In this structure, the reflection unit 220 and the refraction unit 240 constitute a projection system 3. In FIGS. 9 through 11, only the cross dichroic prism 67 as a part of the image forming unit 60 is shown, but other parts are not shown.

The reflection unit 220 has a one curved surface mirror 221. The curved surface mirror 221 is a convexed surface reflection mirror constituted by rotation-symmetric surface around the optical axis OA. The curved surface mirror 221 has a reflection surface 220a (indicated by a solid line in FIG. 9 or other figures) disposed below the optical axis OA and having a refraction layer on the surface. The curved surface mirror 221 has a refraction surface 221a for refracting projection light released from the refraction unit 240, and a reflection surface 221b for reflecting the projection light. The curved surface mirror 221 reflects the projection light projected from the non-projection side of the screen 10 toward the projection surface 10a. A part indicated by a broken line in FIG. 9 or other figures, that is, the part above the optical axis OA indicates a non-real curved surface 220b of the curved surface mirror 221. The curved surface mirror 221 is positioned above the projection side of the screen 10.

The bending mirror 30 is a flat reflection plate which bends the projection light by the reflection surface 30a toward the area before the screen 10, and guides the projection light to the projection side of the screen 10. The bending mirror 30 is disposed above the non-projection side of the screen 10 and between the plural lenses of the refraction unit 240 to be described later. More specifically, the distance s′ between the cross point 30c of the bending mirror 30 and the optical axis OA and a surface top 220c of the curved surface mirror 221 is longer than the distance s between the surface top 220c of the curved surface mirror 221 and the screen projection surface 10a. The bending mirror 30 has an inclination of 45° to the optical axis of the curved surface mirror 221 and the optical axis OA of the refraction unit 240.

The refraction unit 240 is disposed on the exit side of the image forming unit 60. The refraction unit 240 is constituted by a plurality of refractive lenses to enlarge the image on the object surface OS and projects the enlarged image on the screen 10.

The refraction unit 240 includes a lens front group 240A, a lens rear group 240B, and a stop 245. The lens front group 240A has a first lens L201, a second lens L202, a third lens L203, a fourth lens L204, and a fifth lens L205. The lens rear group 240B has a sixth lens L206, a seventh lens L207, an eighth lens L208. The lens front group 240A is disposed on the non-projection side of the screen 10, and the lens rear group 240B is on the projection side of the screen 10. The second lens L202 is constituted by a junction lens having three lenses. The stop 245 is disposed between the lens front group 240A and the lens rear group 240B. The positions of the respective lenses L201 through L208 are controlled such that the optimum projection can be provided on the screen 10 by the control of the relation with the reflection unit 220 in shape and position.

According to this embodiment, the projection light released from the image forming unit 60 passes through the lens front group 240A and the stop 245, and travels toward the lens rear group 240B after bended by the reflection surface 30a of the bending mirror 30. The projection light released from the refraction unit 240 is reflected by the reflection surface 220a of the curved surface mirror 221, and projected on the screen projection surface 10a.

Accordingly, the projector 300 can achieve projection with a large angle of view on the screen 10 while reducing the size and cost of the projector 300 similarly to the projector 100 and other apparatus.

Moreover, the bending mirror 30 is disposed between the plural lenses of the refraction unit 240. Thus, the distance between the curved surface mirror 221 and the exit side end of the refraction unit 240 is shortened. Accordingly, the size of the curved surface mirror 221 can be reduced.

### Fourth Embodiment

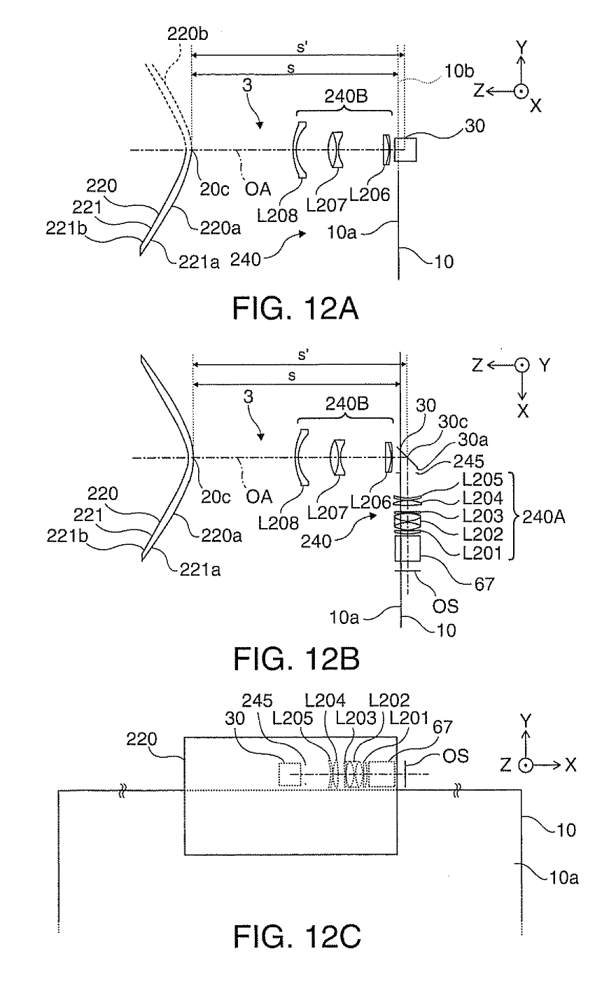

FIGS. 12A through 12C illustrate a concept of a main structure of a projector according to a fourth embodiment of the invention. FIGS. 12A through 12C are side view, plan view and front view of the main structure of the projector as viewed from X axis, Y axis, and Z axis, respectively. A projector 400 in this embodiment is a modification of the projector 300 according to the third embodiment shown in FIG. 9 and other figures, and parts included in the projector 400 similar to those in the projector 300 in the third embodiment are not specifically explained.

The projector 400 in this embodiment includes the screen 10, the reflection unit 220, the bending mirror 30, the refraction unit 240, and the image forming unit 60. In this structure, the reflection unit 220 and the refraction unit 240 constitute the projection system 3. In FIGS. 12A through 12C, only the cross dichroic prism 67 as a part of the image forming unit 60 is shown, but other parts are not shown. In this case, the image forming unit 60 is disposed on the extension plane 10b of the screen 10.

The reflection unit 220 has the one curved surface mirror 221. The curved surface mirror 221 reflects the projection light projected from the extension plane 10b of the screen 10 toward the screen projection surface 10a.

The bending mirror 30 is disposed on the extension plane 10b of the screen 10 and between the plural lenses of the refraction unit 240 to be described later. More specifically, the distance s′ between the cross point 30c of the bending mirror 30 and the optical axis OA and the surface top 220c of the curved surface mirror 221 is longer than a distance s between the surface top 220c of the curved surface mirror 221 and the screen projection surface 10a. The bending mirror 30 has an inclination of 45° to the optical axis of the curved surface mirror 221 and the optical axis OA of the refraction unit 240.

The refraction unit 240 is disposed on the exit side of the image forming unit 60. The refraction unit 240 is constituted by a plurality of refractive lenses to enlarge the image on the object surface OS and projects the enlarged image on the screen 10.

The refraction unit 240 includes the lens front group 240A, the lens rear group 240B, and the stop 245 similarly to the third embodiment. However, the lens front group 240A is disposed on the extension plane 10b of the screen 10, and the lens rear group 240B is disposed on the projection side of the screen 10. The positions of the respective lenses L201 through L208 are controlled such that the optimum projection can be provided on the screen 10 by the control of the relation with the reflection unit 220 in shape and position.

According to this embodiment, the projection light released from the image forming unit 60 travels in the X axis direction along the extension plane 10b of the screen 10, and passes through the lens front group 240A of the refraction unit 240 and the stop 245. Then, the projection light is bended perpendicularly to the extension plane 10b of the screen 10 by using the reflection surface 30a of the bending mirror 30, and travels toward the lens rear group 240B. The projection light released from the refraction unit 240 is reflected by the reflection surface 220a of the curved surface mirror 221, and projected on the screen projection surface 10a.

The structure disposing the bending mirror 30, the refraction unit 240, and the image forming unit 60 on the extension plane 10b of the screen 10 is applicable to the first and second embodiments.

Accordingly, the projector 400 can achieve projection with a large angle of view on the screen 10 while reducing the size and cost of the projector 400 similarly to the projector 300.

The invention is not limited to the embodiments described herein, and various changes and modifications may be made without departing from the scope of the invention. For example, the following modifications may be made.

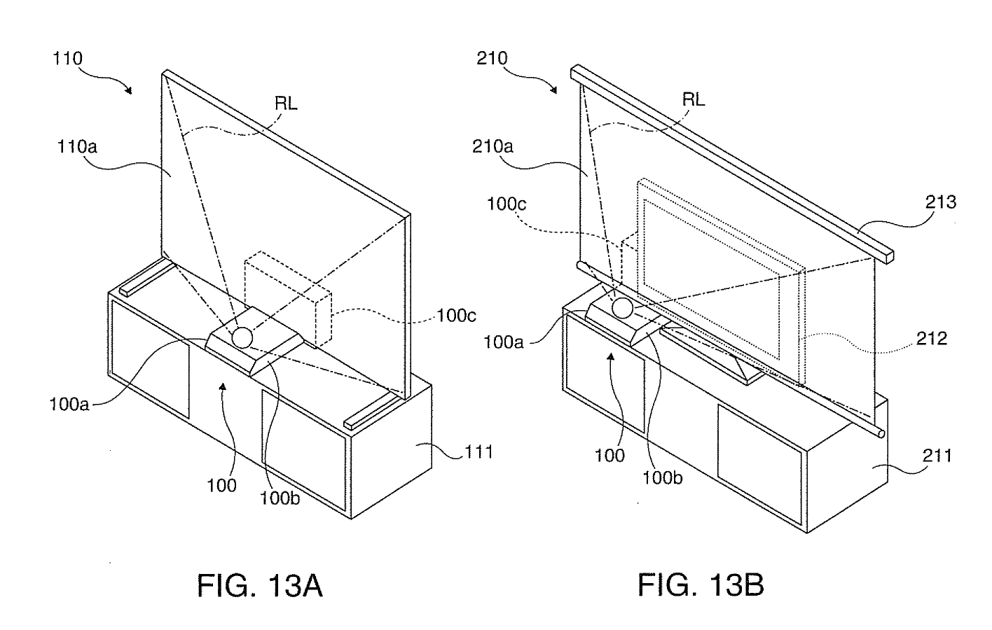

While the reflection units 20, 120 and 220 and the bending mirror 30 are disposed above the screen 10 in the embodiments, these components may be disposed below the screen 10 as illustrated in FIGS. 13A and 13B. According to the structure illustrated in FIG. 13A, a projection unit 100b is disposed before the front surface of a screen 110 on a rack 111, a main body unit 100c is disposed behind the back surface of the screen 110, and projection light RL is projected from the lower position of the screen 110 onto a screen projection surface 110a. According to the structure illustrated in FIG. 13B, the projection unit 100b is disposed at the left lower position in front of a thin TV 212 on a rack 211, and the main body unit 100c is disposed behind the back surface of the thin TV 212. In case of the structure shown in FIG. 13B, the projection light RL is projected on a screen projection surface 210a by lowering a screen 210 toward the front surface of the thin TV 212 at the time of large screen viewing. The screen is accommodated in a roll storage unit 213 when the projector 100 or the like is not used.

While the liquid crystal light valves 65a, 65b, and 65c are used as image forming elements of the image forming unit 60 in the embodiments, an image forming unit such as light modulation device, film, and slide as devices containing pixels constituted by micromirrors may be used.

The entire disclosure of Japanese Patent Application No. 2007-290462, filed Nov. 8, 2007 is expressly incorporated by reference herein.

What is claimed is:

1. A projector, comprising:
a screen;
a reflection unit having at least one curved surface mirror disposed on the projection side of the screen;
a bending mirror disposed before the reflection unit on the optical path and disposed on either the non-projection side of the screen or on an extension plane of the screen;
a refraction unit disposed before the reflection unit on the optical path and having at least a part disposed on either the non-projection side of the screen or on the extension plane of the screen; and
an image forming unit disposed before the refraction unit on the optical path and disposed on the non-projection side of the screen.

2. The projector according to claim 1, wherein the curved surface mirror has either a concave surface or a convex surface as a curved reflection surface.

3. The projector according to claim 1, wherein a projection distance from the reflection curved surface of the curved surface mirror to the screen is shorter than a distance from the reflection curved surface of the curved surface mirror to the bending mirror.

4. The projector according to claim 1, wherein the refraction unit has a plurality of lenses.

5. The projector according to claim 4, wherein the bending mirror is disposed between the plural lenses.

6. The projector according to claim 4, wherein the all or partial optical axis of the plural lenses is disposed parallel with the extension plane of the screen on either the non-projection side of the screen or the extension plane of the screen.

7. The projector according to claim 1, wherein the bending mirror is disposed on the exit side of the refraction unit.

8. The projector according to claim 1, wherein the image forming unit has an image forming element.
